(19) United States
(12) Patent Application Publication
(10) Pub. No.: US 2012/0108245 A1
(43) Pub. Date: May 3, 2012

(54) Energy Reduction in Cooperating Radio Access Systems

(75) Inventors: Haibin Zhang, The Hague (NL); Job Cornelis Oostveen, Haren (NL); Ljupco Jorguseski, Rijswijk (NL); Remco Litjens, Voorschoten (NL); Adrian Victor Pais, Rijswijk (NL)

(73) Assignees: Nederlandse Organisatie Voor Toegepast-Natuurweten -schappelijk Onderzoek TNO, Delft (NL); KONINKLIJKE KPN N.V., The Hague (NL)

(21) Appl. No.: 13/383,155

(22) PCT Filed: Jul. 9, 2010
(86) PCT No.: PCT/EP2010/059908

§ 371 Date: Jan. 9, 2012

(30) Foreign Application Priority Data
Jul. 15, 2009 (EP) 09009217.2
Jan. 18, 2010 (EP) 10150974.3
May 10, 2010 (EP) 10162417.9

(51) Int. Cl. H04W 52/02; H04W 36/16

(52) U.S. Cl. 455/443

(57) ABSTRACT

The invention relates to cooperation between first and second wireless access networks that can be used to obtain energy reduction for or traffic routing within the overall telecommunications infrastructure while still enabling acceptable network coverage and satisfactory performance by the telecommunications infrastructure as a whole. The cooperation refers to the fact that the wireless access networks provide duplicate coverage in a particular area when both wireless access networks are active, and that traffic can be switched between the cooperating networks in order to temporarily adjust (e.g. switch off) resources of one or the wireless access networks. In this manner, energy reduction and/or traffic routing can be obtained under the constraint that sufficient service coverage and capacity remains at an acceptable quality.

System and method for controlling energy consumption in a telecommunications infrastructure

### FIELD OF THE INVENTION

The invention relates to the field of telecommunications infrastructures. More specifically, the invention relates to the field of controlling energy consumption, particularly reducing energy consumption, in telecommunications infrastructures comprising wireless access networks.

### BACKGROUND OF THE INVENTION

The operation of wireless access networks for enabling wireless communication is highly energy consuming. In view of current environmental concerns, increased attention is paid recently to the energy consumption of telecommunications networks.

Various studies have been performed to reduce conventional energy consumption in wireless access networks, e.g. by exploring the option of using sustainable energy sources (Ericsson AB White Paper “Sustainable energy use in mobile communications, June 2007).

With the development of the 3GGP Long Term Evolution (LTE) network, energy saving for the network is approached in the context of self-organizing networks (SON). In a White Paper of NEC, dated February 2009, “NEC's proposals for next-generation radio network management”, energy is considered as a significant part of the operation expenses of a cellular network. It is recognized that the main saving potential resides in using variations in load over time, that allows to switch off parts of the resources, for example during night. When a complete base station is switched off, other base stations of the access network need to make up for the reduction in coverage area and capacity. This requires coordination between the nodes. A similar use case is currently described in V1.2.0 of 3GGP TR 36.902.

A specific example of temporarily switching off base stations is disclosed in WO 2009/031956. The disclosure relates to an energy saving method for a telecommunication system comprising a single access network. In the telecommunication system, a signal having a frame structure is transmitted by each base station sector (i.e. in each cell). This frame structure has an overhead part with at least some synchronization or system information. In a normal mode of operation, this signal has a first coverage area. In a power saving mode of operation, different from the normal mode of operation, the signal is transmitting within the cell covering a second area larger than the first area, such that other base stations can be switched off. The power saving mode is activated at certain operating conditions, such as the level of usage for the cell capacity, the number of user terminals in the cell and/or statistics of cell usage over time. The power saving mode may be activated if the traffic load is below a certain level. The increase of the second area can be obtained by increasing the transmit power level or by employing different antenna devices in the power saving mode.

A similar method for adaptive power management for a node of a cellular telecommunications network has been disclosed in WO 02/07464. In said disclosure, coordination between base stations of a single wireless access networks is disclosed to remove remaining traffic from a carrier to be removed for saving power to another carrier, including a step of determining whether traffic currently on the former carrier can be removed to the latter carrier.

### PROBLEM DEFINITION

A problem in the above-mentioned prior art systems is that the adaptation of the nodes, e.g. the base stations, within the telecommunications network is performed in order to save energy as soon as the condition for the power saving mode is fulfilled regardless whether the telecommunications network will remain able to operate at an acceptable performance. As an example, the adaptation of the node by increasing the coverage area may result in interference with nodes of neighbouring areas

### SUMMARY OF THE INVENTION

A network control system is disclosed for controlling a telecommunications infrastructure. The network can be configured for controlling energy consumption, for traffic routing optimization and for other purposes in the telecommunications infrastructure. The telecommunications infrastructure comprises a first wireless access network and a second wireless access network. The first wireless access network and second wireless access network contain at least one overlapping coverage area, e.g. a (major part of a) cell, that is shared by the first and second wireless access network. The first wireless access network and second wireless access network are capable of providing services to a plurality of first terminals and second terminals, respectively in the overlapping coverage area. The first and second terminals are the terminals that would initially communicate with the first and second wireless access networks, respectively, when both these networks provide coverage in the overlapping coverage area, as a result of e.g. the internal settings in the respective terminals. The first and second wireless access networks refer to different networks having e.g. different radio access network technologies.

The network control system, which may be implemented in one or more nodes or elements of the telecommunications infrastructure, contains a monitoring system configured for monitoring the claimed capacity in at least the overlapping coverage area by the first terminals in the first wireless access network and for monitoring the free capacity of the second wireless access network for providing the services in at least the overlapping coverage area.

In the present disclosure, the term “capacity” may have different meanings, and therefore, capacity translation between the first and second wireless access networks may be needed, for if there are two different wireless access networks.

The term “capacity” can relate an absolute value defined as the amount of raw data bits (thus without any overhead) that are transmitted by a wireless network in one time unit (e.g. second). In such a case normally no capacity translation is necessary.

The term “capacity” may relate to an absolute value defined as the amount of radio channel bits (thus raw data bits with or including the overhead, such as redundancy introduced by error-correction coding, training sequences/pilot signals etc.) that are transmitted by a wireless network in one time unit. In such a case, capacity translation may be needed. Assume that the first wireless access network transmits A1 raw data bits with B1 overhead bits in one time unit, while for the second wireless access network are A2 raw data bits and B2 overhead bits are transmitted. The capacity of C1 for the first wireless access network may then e.g. be translated into a capacity of C1−B1+B2 for the second wireless access network.

The term “capacity” may relate to a relative value (for example in percentage) defined as the ratio of the amount of raw data bits (or radio channel bits) that are transmitted by a wireless network to the maximum number of transmittable raw data bits (or radio channel bits) in one time unit. In such case capacity translation may also be needed. Assume that the first wireless access network can maximally transmit Am1 raw data bits (or radio channel bits) in one time unit, while for the second wireless access network Bm1 raw data bits can be transmitted. The capacity of R1 for the first wireless access network can be translated into a capacity of R1·Am1/Am2 for the second wireless access network.

In the sequel, it is to be understood that no capacity translation is needed or that capacity translation is implicitly performed when capacities of two different wireless access networks are to be related or compared.

The claimed capacity in the first wireless access network comprises the actually used capacity by the first terminals at a particular point in time for a particular performance. The free capacity of the second wireless access network comprises the capacity not used by the active second terminals in this network at a particular point in time at a particular performance. In other words, the free capacity of the second wireless access network may be defined as the installed capacity of the second wireless access network minus the claimed capacity by the second terminals.

The network control system is configured for handing over one or more of the first terminals in the overlapping coverage area from the first wireless access network to the second wireless access network after the free capacity in the second wireless access network exceeds the claimed capacity in the first wireless access network and providing services to the first terminals in the second wireless access network. In order to control the energy consumption, here to reduce the energy consumption, in the telecommunications infrastructure, as one application of the invention, one or more resources of the first wireless access network are adjusted. Adjustment of a resource includes the adjustment of a parameter of such a resource.

In the present disclosure, the term ‘resource’ can be defined as any aspect of a system or component that plays a role in the functioning of the system or component. Typically, a resource relates to any aspect that can possibly be exhausted and therewith defines the capabilities of a system or component, or the limitations thereof. A ‘resource’ may be found in subsystems, modules or components commonly recognised in a system, such as (the number of) transmitters or (the number of) processors and associated equipment to carry out e.g. signal processing, channel coding/decoding, etc. (by some manufacturers also referred to as ‘channel elements’) or to carry out signalling or operation and maintenance tasks. A system may have a certain number of such subsystems/components present and installed. Controlling the number of active subsystems/components of a same or similar kind (e.g. the number of transmitters controlled to be active) may control the aggregated resources available to the system.

The term, ‘resource’ may also relate to an aspect of a particular subsystem/module/component which is not easily distinguishable as a separate entity. Examples of such resources include, amongst others, the power used to transmit at a given carrier (frequency), the duration a particular signal is transmitted, the coding scheme and/or the type of modulation to transmit a particular signal (possibly affecting the achievable user bit rate), the width of the spectrum in which a signal is transmitted, the number of different frequencies on which is transmitted (e.g. frequency bands, carrier frequencies, subcarriers etc.), the number of traffic streams (e.g. calls) processed by a processor (‘channel element’) and/or the number of cores and/or the clock frequency and/or voltage with which a processor is operated. In the above examples, the resource is not easily distinguishable as a separate entity but is nevertheless commonly recognised as an aspect that defines (a limit to) the capabilities of a module/component. At a particular moment, such resources can be said to be ‘in use’ (‘used’) and correspond to a certain ‘load’ on the module or, alternatively can be said to be ‘available’ (‘free’).

In the ultimate case, all first terminals in the overlapping coverage area are handed over from the first wireless access network to the second wireless access network and one or more of the resources of the first wireless network are adjusted by switching off these resources. However, energy consumption may also be reduced by less severe measures, such as reducing the transmission power of a base station of the first wireless access network (possibly resulting in a decrease of the coverage area of this base station), wherein the first terminals no longer able to communicate with the first wireless access network (e.g. when falling e.g. out of the range of the base station) are handed over to the second wireless access network covering the area. Since the different first and second wireless access network were operative simultaneously before handing off the first devices and the second wireless access network as such remains operative (with possibly some adaptations) after hand-over, the second wireless access network is likely to still have an appropriate performance.

Also, a method for controlling a telecommunications infrastructure as defined above is disclosed. The purpose of the control may again relate to controlling energy consumption, for traffic routing optimization and/or other purposes.

The claimed capacity used in at least the overlapping coverage area of the first wireless access network by the first terminals is monitored. Also, the free capacity in the second wireless access network for providing services in the overlapping coverage area is monitored. A handover indication is provided after the free capacity in the overlapping coverage area of the second wireless access network exceeding the claimed capacity by a significant degree in the overlapping coverage area in the first wireless access network if this allows reduction of energy-consuming resources.

After obtaining the handover indication, one or more of the first terminals in the overlapping coverage area are handed over from the first wireless access network to the second wireless access network for providing services to the first terminals from the second wireless access network. Energy consumption may e.g. be controlled, i.e. reduced in the present case, by adjusting one or more resources of the first wireless access network. In the ultimate case, all first terminals in the overlapping coverage area are handed over from the first wireless access network to the second wireless access network and one or more of the resources of the first wireless network are adjusted by switching off these resources. Again, energy consumption may also be reduced by less severe measures, such as reducing the transmission power of a base station of the first wireless access network (possibly resulting in a decrease of the coverage area of this base station), wherein the first terminals are no longer able to communicate with the first wireless access network (e.g. falling out of the range of the base station) are handed over to the second wireless access network covering the area.

Accordingly, cooperation between the first and second wireless access networks can be used to obtain energy reduction for the overall telecommunications infrastructure while still enabling acceptable network coverage and satisfactory performance by the telecommunications infrastructure as a whole. The cooperation refers to the duplicate coverage that the wireless access networks may provide in a particular area when both wireless access networks are active, and that traffic can be switched between the cooperating networks in order to temporarily adjust (e.g. switch off) resources of one or the wireless access networks. In this manner, the operation of the telecommunications infrastructure can be optimized in terms of energy reduction under the constraint that sufficient service coverage and capacity remains at an acceptable quality.

It should be noted that for the handover decision, the use of resources of the first network by the first terminals is used to estimate the impact of a handover on the capacity in the second network will be. However, at least one correction factor for the claimed capacity and/or free capacity may apply in cases where a one-to-one correspondence of these parameters between the first and second network is unrealistic. The correction factor may e.g. be related to a difference in distance of a first terminal from a base station of the first network and a base station of the second network. Moreover, it may be that a conversion factor should apply when resource units in the first and second wireless access network are expressed differently, as mentioned previously in the present application.

Several resources, as defined in detail previously in the present application, may be selected to be adjusted or switched off temporarily in order to reduce energy consumption. As indicated, examples may include an entire base station of the first wireless access network, a part of a base station, such as a sector or a cell, (a part of) the installed spectrum, processing boards, transmission carriers etc. or parameters thereof.

It should be appreciated that while the decision for handing over the first terminals is made by the network control system, the actual handover of the terminals and/or the adjustment of the resources may be performed in the telecommunications infrastructure in a manner known to the skilled person upon instructions of the network control system.

The capabilities of the first terminals may also be communicated to the network control system (either explicitly by sending these capabilities from the terminals to the wireless access network or deriving the capabilities from the terminal from another entity in the infrastructure or implicitly by monitoring which services are used by the terminal) in order to verify whether the first terminals are capable of using the second wireless access network for obtaining at least some of the services (possibly at a different quality) that could be used in the first wireless access network. The handover decision algorithm may also take the terminal capabilities into account.

The network control system may be configured for adapting one or more network elements of the second wireless access network in order to serve the one or more first terminals in the second wireless access network in order to compensate for adjusting resources of one of the wireless access networks, the resources (or parameters thereof) of the other wireless access network may need to be adjusted to keep the coverage and quality by the telecommunications infrastructure at an acceptable level for the first and second terminals. Examples of (parameters of) resources that may need to be adjusted include transmission power, beam forming patterns, handover thresholds, neighbouring cell lists etc.

It is noted that handover from the one or more first terminals to the second wireless access network does not necessarily occur immediately after detecting that the free capacity in the second wireless access network exceeds the claimed capacity by the first terminals in the first wireless access network. As an example, some delay may be taken into account to avoid unlimited handing over due to fluctuations of the claimed capacity and free capacity, defining a hysteresis loop and time intervals for the handover procedure.

Furthermore, the network control system may be configured for handing over the one or more first terminals to the second wireless access network when the monitored claimed capacity by the first terminals is below a claimed capacity threshold and/or when the monitored free capacity in the second wireless access network is above a free capacity threshold. In other words, handing over of the first terminals to the second wireless access network may be made dependent on one or more threshold conditions in order to avoid that each time the free capacity in the second wireless access network exceeds the claimed capacity in the first wireless access network, one or more first terminals are handed over. This may avoid unnecessary signalling in the telecommunications network and/or prevent excessive handovers and/or inefficient adjustment of the resources on too fine a time scale.

The applicant has acknowledged that the claimed capacity by a first terminal in the first wireless access network will generally differ from the claimed capacity by this terminal in the second network when handed over to the second network, e.g. because of the different distances to the base station of first and second wireless access networks. Moreover, the applicant has acknowledged that the claimed capacity and free capacity in the wireless access networks is related to the quality of service (the performance) for the terminals in these networks. These insights enable an improved network control while guaranteeing satisfactory performance as defined in claims 2, 3, 10 and 11.

The embodiments of claims 2 and 10 allow to take into account the (minimum) performance (referred to above as quality of service) for the one or more first terminals in the first wireless access network before handing over to the second wireless access network. The handover is only performed when a minimum quality of service can be expected also in the second wireless access network. Of course, another aspect that may be taken into account is whether the (minimum) quality of service for the second user terminals can still be fulfilled, either in addition to the quality of service requirements for the first user terminals or as an alternative. An example of a quality of service parameter that may be analysed is the (minimum) throughput for a terminal or service, which is valid mainly for realtime services such conversational voice, life video streaming and real-time network gaming. Two other examples are the affordable delay and packet loss rate, which differ per type of services. For example, as specified in 3GPP TS 23.203, the delay budget for TCP-based services is 300 ms while the delay budget for real-time network gaming is 50 ms. Further, the packet loss rate of conversational voice is 10⁻² while the packet loss rate for TCP-based services amounts to 10⁻⁶.

The embodiments of claims 3 and 11 allow manipulation of the claimed capacity and/or free capacity in at least one of the wireless access networks. In these embodiments, the claimed capacity by the first terminals may be defined as the capacity taken by the first terminals when the minimum quality of service target for these terminals is provided by the first wireless access network, thus decreasing the originally claimed capacity in the first wireless access network at a higher quality of service level. The free capacity is now defined as the unused capacity when the active second terminals are served at the minimum quality of service target by the second wireless access network, thus increasing the original free capacity. Accordingly, the handover of one or more terminals from the first wireless access network to the second wireless access network is promoted.

At some point in time, one or more of the adjusted resources of the first wireless access network may be needed again.

Therefore, in another aspect of the invention, a network control system configured for controlling a telecommunications infrastructure is disclosed. Again, the telecommunications infrastructure comprises a first wireless access network and a second wireless access network, the first and second wireless access network being capable of providing services in an overlapping coverage area to a plurality of terminals. The system comprises a monitoring system configured for monitoring via the second wireless access network the claimed capacity by the terminals and/or the free capacity in the second wireless access network when the first wireless access network does not yet serve terminals in at least the overlapping coverage area.

The network control system is configured for adjusting one or more resources of the first wireless access network after the claimed capacity by the terminals exceeds a claimed capacity threshold in the second wireless access network and/or the free capacity in the second wireless access network gets below a free capacity threshold, wherein the network control system is also configured for handing over one or more of the terminals in the overlapping coverage area from the second wireless access network to the first wireless access network using the adjusted resources of the first wireless access network such that the claimed capacity by the terminals remaining in the second wireless access network is lowered to at least the claimed capacity threshold and/or the free capacity of the second network is increased to at least the free capacity threshold.

Furthermore, a method for controlling a telecommunications infrastructure comprising a first wireless access network and a second wireless access network is disclosed. The first and second wireless access network are capable of providing services in an overlapping coverage area to a plurality of terminals. The claimed capacity by the terminals is monitored via the second wireless access network, when the first wireless access network does not serve terminals in the overlapping coverage area.

Resources of the first wireless access network are adjusted after the claimed capacity by the terminals exceeds a claimed capacity threshold for the second wireless access network. One or more of the terminals are handed over from the second wireless access network to the first wireless access network using the adjusted resources of the first wireless access network such that the claimed capacity by the terminals remaining in the second wireless access network is lowered to at least the claimed capacity threshold.

The claimed capacity in the second wireless access network comprises the actually used capacity by the terminals at a particular point in time and at a particular performance. The free capacity of the second wireless access network comprises the capacity not used by the active terminals in this network at a particular point in time and at a particular performance. In other words, the free capacity of the second wireless access network may be defined as the installed capacity of the second wireless access network minus the claimed capacity by the active terminals.

Thus, the second wireless access network is used for obtaining information in order to decide whether resources need to be adjusted in the first wireless access network, and whether terminals should be handed over to the first wireless access network. This is advantageous, since the adjustment of the resources of the first wireless access network after handing over terminals to the second wireless access network, as described above, may imply that the first wireless access network itself is no longer capable of obtaining this information. When the monitored claimed capacity by the terminals as monitored via or by the second wireless access network exceeds a claimed capacity threshold, one or more of the terminals will be handed over to the first wireless access network after the resources of the first network are adjusted.

It should be appreciated that after having handed over the first terminals to the second wireless access network, as described previously, it will not always be possible to identify these same terminals, if still present in the overlapping area, and to hand over one or more of these same terminals back to the first wireless access network after the claimed capacity threshold in the second wireless access network is exceeded. Therefore, the handing over of one or more terminals back to the first wireless access network may include one or more of the original second terminals. This process may possibly be accompanied by adjusting one or more resources of the second wireless access network in order to e.g. reduce energy consumption for the second wireless access network.

In order to allow the terminals camping on the cells of the second wireless access network to return to the first wireless access network, the second wireless access network signals the availability, and possibly advertises characteristics, of the first wireless access network as defined in claims 5 and 13. Examples of such characteristics include the radio access technology (e.g. GSM, UMTS, LTE, WiMax), the used frequency spectrum and/or the network operator (the PLMN ID).

The embodiments of claims 6 and 14 are advantageous in that the resources of the first wireless access network to be adjusted in order to allow handover to the first wireless access network can be determined in dependence on determined parameters of the terminals served currently by the second wireless access network, such that only resources of the first wireless access network that are actually required can be adjusted (e.g. switched on again) for serving the handed over terminals. This enables intelligent adjustment of the resources of the first wireless access network and, therefore, may assist in controling e.g. the energy consumption of the telecommunications infrastructure. It should be noted that the first wireless access network may participate in the decision process.

Generally, it should be appreciated for the present disclosure that the first and second access wireless access network may respectively comprise (but are not limited to): (i) a first network using a first radio access technology and a second network using a second different radio access technology (examples include a first network using GSM and a second network using UMTS; a first network using UMTS and a second network using LTE; a first network using UMTS and a second network using WiMAX), (ii) a first network using a first radio access technology and a second network using the same radio access technology as the first network but operated independently and using separate physical resources than the first network (an example is an operator that owns and operates a GSM network may acquire or cooperate with another completely separate (in terms of equipment and operation) GSM network from another operator), (iii) a first network of a first network operator and a second network of a second network operator (examples include but are not limited to a GSM network owned by Operator A and a GSM network owned by Operator B; a GSM network owned by Operator A and a UMTS network owned by Operator B and (iv) a first network comprising cells of a first dimension and a second network comprising cells of a second dimension, different from the first dimension (examples include but are not limited to a first network comprising macro cells and a second network comprising micro cells; a first network comprising macro cells and a second network comprising femto cells).

Thus, the first and second wireless access networks may differ in radio access technology (e.g. GSM and UMTS or UMTS and LTE), the deployed release of a given radio access technology, used frequency spectrum (e.g. the 900 MHz and 1800 MHz frequency bands (the latter also being referred to as a DCS network) for GSM, different 5 MHz carriers for UMTS) and/or in different mobile operator. The wireless access network may also differ in the type of cells provided, e.g. macro cells and pico cells. As an example, in order to e.g. reduce energy consumption, first terminals camping on a cell of a UMTS network as a first wireless access network may be handed over for that cell to a GSM network when the claimed capacity in the UMTS network is low and the free capacity in the GSM network is sufficient to accommodate the used capacity by the first terminals in the UMTS network (possibly also verifying whether the capabilities of the terminals allow communication with the GSM network and the minimum quality of service can be guaranteed in the GSM network). The UMTS network may then be adjusted (e.g. by switching off the UMTS NodeB) in order to save energy. As another example, a NodeB providing services to first terminals via a first 5 MHz carrier and to second terminals via a second 5 MHz carrier, may handover the first terminals to the second 5 Mhz carrier and switch off the first 5 MHz carrier when capacity and performance of the second carrier is sufficient to accommodate the claimed capacity by the first terminals on the first 5 MHz carrier.

Furthermore, the telecommunications infrastructure disclosed herein may comprise at least one operations and maintenance centre and the first and second wireless access networks may comprise a plurality of first and second base stations, respectively, wherein at least a part of the network control system is contained in the operations and maintenance centre and/or the first and/or second base stations. Dependent on the nature of the difference between the first and second wireless access network, the hierarchical level of implementation of the network control system in the telecommunications infrastructure may be decided. When the first and second wireless access networks are e.g. from different vendors, the operations and maintenance centres (or equivalent network elements) for the wireless access networks can be used for the implementation of the network control system. The operations and maintenance centres may be integrated when the first and second wireless access networks are from different network operators, but from the same vendor. When the first and second wireless access networks are obtained from a single vendor, (e.g. an operator offering both a 3G and a 4G network from the same vendor), (a part of) the network control system functionality may be implemented in the wireless access network, e.g. in the base station, NodeB or eNodeB, wherein these network elements may exchange information relevant for the energy consumption control, either via another network element (such as the RNC) or directly via e.g. the Itf-X2 in LTE networks. Eventually, third party systems may also be used for implementing (a part of) the network control system.

Again, the applicant has acknowledged that the claimed capacity by a terminal in the second wireless access network will generally differ from the claimed capacity by this terminal in the first wireless access network when handed over to the first network, e.g. because of the different distances to the base station of first and second wireless access networks. Moreover, the applicant has acknowledged that the claimed capacity and free capacity in the wireless access networks is related to the quality of service for the terminals in these networks. These insights enable an improved energy control while guaranteeing satisfactory performance as defined in claims 7, 8, 15 and 16.

The embodiments of claims 7 and 15 allow to take into account the (minimum) performance (referred to above as quality of service) for the one or more terminals in the second wireless access network before handing over to the first wireless access network. The handover is only performed when a minimum quality of service can be expected also in the first network. An example of a quality of service parameter that may be analysed is the (minimum) throughput for a terminal. Of course, another aspect that may be taken into account is whether the (minimum) quality of service for the second user terminals can still be fulfilled, either in addition to the quality of service requirements for the first user terminals or as an alternative. An example of a quality of service parameter that may be analysed is the (minimum) throughput for a terminal.

The embodiments of claims 8 and 16 allow manipulation of the claimed capacity and/or free capacity in the second wireless access network. In these embodiments, the claimed capacity by the terminals may be defined as the capacity used by the terminals when the minimum quality of service target for these terminals is provided by the second wireless access network, thus decreasing the original claimed capacity in the second wireless access network. The free capacity is now defined as the unused capacity when the active terminals are served at the minimum quality of service target by the second wireless access network, thus increasing the original free capacity. Accordingly, the handover of one or more terminals from the second wireless access network to the first wireless access network is demoted.

It should be noted that a part of the decision algorithm to handover terminals from the first wireless access network to the second wireless access network and vice versa may involve energy reduction estimation in order to verify whether a (considerable) energy reduction is indeed obtained. This is particularly true when network resources are not completely switched off, but only modified.

As indicated previously in the present disclosure, it should be noted that other than energy saving, there are several other applications of the network control system, including but not limited to:
reducing radiation due to switching off one or more base stations in one or more of the wireless access networks of the telecommunications infrastructure;
reducing network interference due to switching off one or more base stations in the one or more wireless access networks of the telecommunications infrastructure;
freeing up spectrum resources to allow secondary users of a cognitive network to access the available spectrum;
managing, steering, routing and/or controlling traffic across or between two or more different wireless access networks in order to make optimal use of network resources of the telecommunications infrastructure, including, but not limited to: backhaul (transmission) capacity, core network capacity, and services;
creating the possibility to free-up and sell overcapacity (i.e. the emptied resources in the first wireless network).

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIGS. 1A and 1B provide schematic illustrations of telecommunication infrastructures comprising a first and a second wireless access network sharing a coverage area;

FIGS. 2A and 2B provide a schematic illustration of a network control system and a simplified diagram illustrating handing over first terminals to the second network based on used capacity and free capacity using the network control system;

FIGS. 3A and 3B depict basic flow charts for adjusting the first wireless access network upon handing over first terminals to the second wireless access network respectively handing over the first terminals back to the first wireless access network;

FIGS. 4A and 4B depict more detailed flow charts for adjusting the first wireless access network upon handing over first terminals to the second wireless access network respectively handing over the first terminals back to the first wireless access network;

FIGS. 5A and 5B provide a schematic illustration of a practical example of adjusting the first and second wireless access communication network for reducing energy consumption; and

FIGS. 6A-6C depict examples of scenarios for monitoring load in the second wireless access network that can potentially be handed over to switched off resources of the first wireless access network.

### DETAILED DESCRIPTION OF THE DRAWINGS

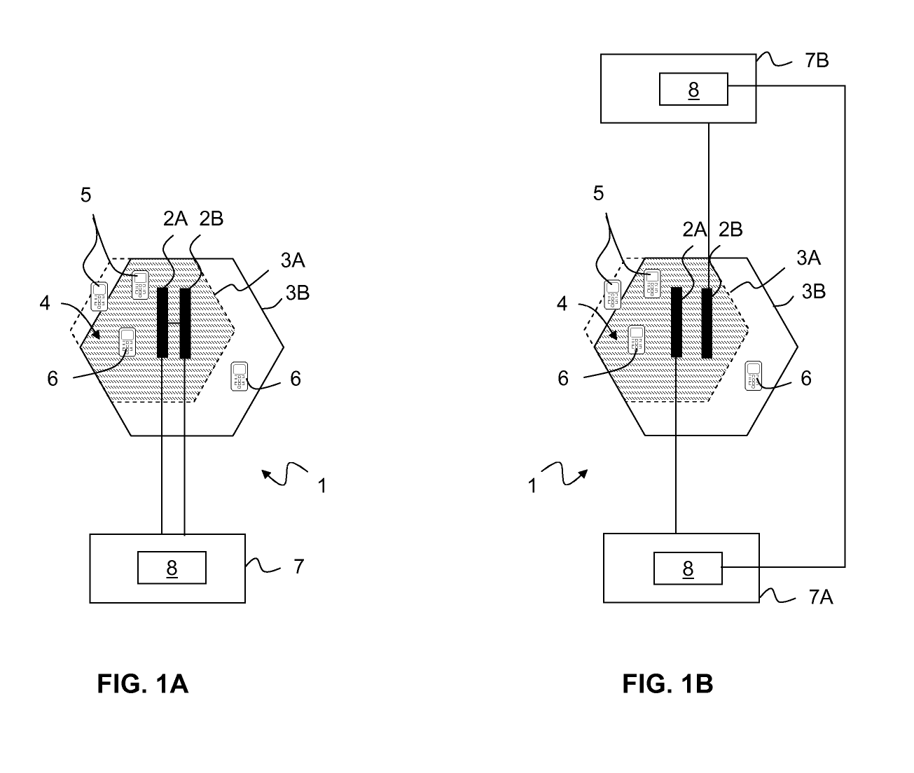

FIGS. 1A and 1B provide schematic illustrations of telecommunications infrastructures 1 comprising a first wireless access network and a second wireless access network, represented here by two different nodes 2A and 2B (e.g. base stations, NodeBs and/or eNodeBs) defining respective coverage areas 3A (dashed lines) and 3B (solid lines). The coverage areas 3A, 3B define an overlapping coverage area 4. It should be noted that the dimensions of the coverage areas 3A, 3B may not be constant in time.

A plurality of first mobile terminals 5 is associated with the first wireless access network 2A and a plurality of second mobile terminals 6 is associated with the second wireless access network 2B. As an example, the first mobile terminals 5 may be programmed to connect to the first wireless access network 2A when active and the second mobile terminals 6 may be programmed to connect to the second wireless access network 2B when active. In this situation, the first wireless access network 2A provides telecommunications services to terminals 5 and the second wireless access network 2B provides telecommunications services to terminals 6, even for the first terminals 5 being also in cell 3B of the second wireless access network 2B and for the second terminals 6 being also in the cell 3A of the first telecommunications network 2A. It should be clear that each of the depicted terminals 5, 6 may represent a plurality of mobile terminals.

In the infrastructure 1 of FIG. 1A, the first and second wireless access networks 2A, 2B are from a single vendor and may thus be operated from a single operation and maintenance centre (OMC) 7. The nodes 2A, 2B may be connected over an interface (for an LTE network). The first and second wireless access networks 2A, 2B may differ in radio access technology (e.g. GSM and UMTS or UMTS and LTE) or the used frequency spectrum (e.g. the 900 MHz and 1800 MHz frequency bands (the latter also being referred to as a DCS network) for GSM or different 5 MHz carriers for UMTS). It should be noted that the nodes 2A, 2B may be provided on a single physical location.

In the infrastructure of FIG. 1B, the first and second wireless access networks 2A, 2B are e.g. from different vendors and each of the first and second wireless access networks 2A, 2B is operated from a corresponding OMC 7A, 7B. The OMCs 7A, 7B are at least connected in order to exchange information for controlling the telecommunications infrastructure, e.g. for controlling energy consumption as described in further detail below.

It should be appreciated that further network elements may be arranged in the telecommunications infrastructures 1 of FIGS. 1A and 1B between the OMC and the nodes 2A, 2B of the corresponding wireless access networks, as known to the person skilled in the art.

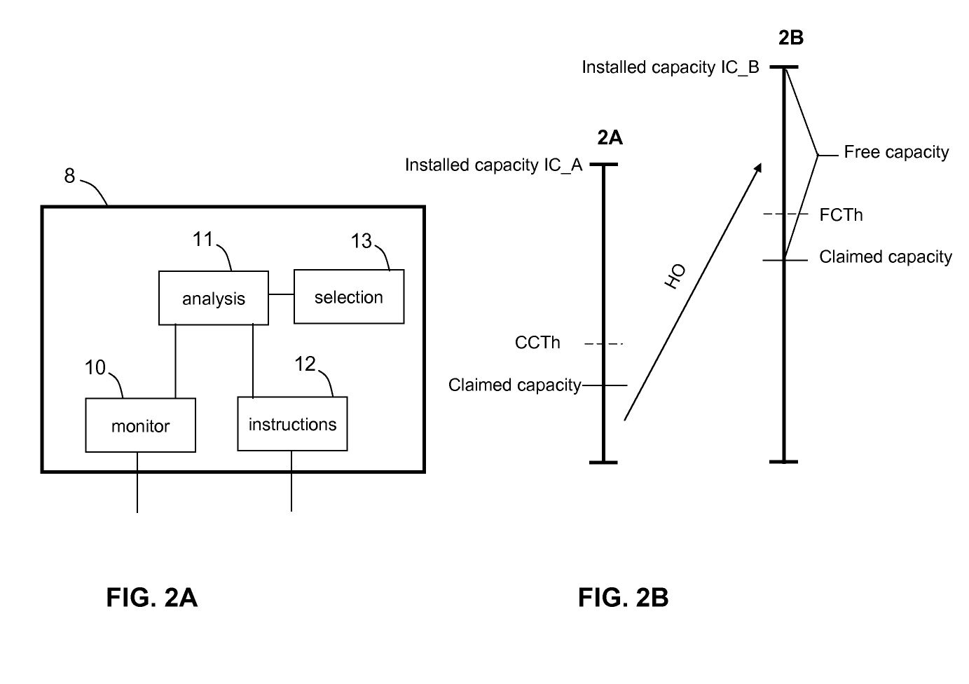

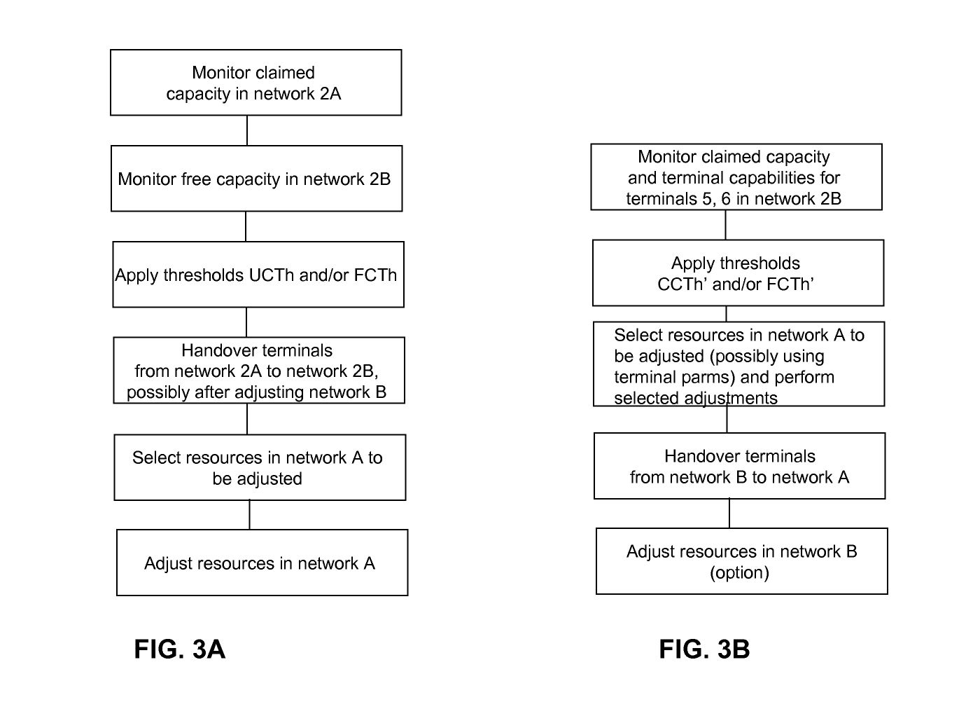

In the telecommunications infrastructures 1 of FIGS. 1A and 1B, the OMC 7 comprises a network control system 8, the operation of which will be further described with reference to FIGS. 2 and 3. However, the network control system 8 is not necessarily implemented in such a centralised manner, but may also be decentralised (distributed) by implementing energy control functionality in other network elements, such as base stations, NodeBs and/or eNodeBs and using connections between these elements. Hybrid implementations are also envisaged. Signals for energy control can be exchanged over management or traffic interfaces.

The network control system 8 comprises a monitoring module 10, an analysis module 11 and an instruction module 12 as depicted schematically in FIG. 2A. These modules may be largely implemented as software executed by a processor and making use of memory (not shown). One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive, flash memory or hard-disk drive or any type of solid-state random-access semiconductor memory) on which alterable information is stored.

FIG. 3A is a basic flow chart illustrating an embodiment of the operation of the network control system 8.

The monitoring module 10 monitors the claimed capacity by first terminals 5 in the first wireless access network 2A and by second terminals 6 in the second wireless access network 2B by receiving indications of the used capacity by these terminals in at least the overlapping area 4, using information from the first and second wireless access networks, in particular nodes thereof. Further information, such as the capabilities of the terminals 5, 6 and the (minimum) required performance (quality of service) may also be received or derived.

As illustrated in FIG. 2B, the installed capacity in the first and second wireless access networks 2A, 2B may be different. Typically, a part of the installed capacity is used by terminals 5, 6 of the respective wireless access networks 2A, 2B. The remaining capacity, i.e. the capacity not used, is referred to as the free capacity.

The monitored data is provided to the analysis module 11 of the network control system 8. The analysis module 11 verifies whether the claimed capacity by the first terminals in the first wireless access network 2A is below a claimed capacity threshold CCTh, illustrated in FIG. 2B. Furthermore, the analysis module 11 verifies whether the free capacity in the second wireless access network 2B is sufficient for handing over one or more of the first terminals 5 to the second network. In this verification step, the analysis module 11 may take account of a free capacity threshold FCTh.

When the claimed capacity in the first wireless access network 2A is above the claimed capacity threshold CCTh, the first terminals 5 are not handed over to the second wireless access network 2B. Also, when the free capacity in the second wireless access network 2B is not sufficient (or remains below the free capacity threshold FCTh), the first terminals 5 remain in the network 2A.

Only when the used capacity is below the claimed capacity threshold CCth and the free capacity is above the free capacity threshold FCTh (the part between the used capacity level and FCTh remains reserved for terminals 6) and provided that energy consumption can indeed be reduced, one or more of the first terminals 5 are handed over to the second wireless access network 2B, as illustrated by the arrow HO in FIG. 2B. The handover instructions for the first and second wireless access networks 2A, 2B are provided using an instruction module 12 of the network control system 8. The second wireless access network 2B may need to be adjusted to enable service coverage in the affected network, i.e. the radio parameters of the residual cells may be jointly optimised in order to jointly provide the best possible coverage and/or capacity. This can e.g. be achieved by adjusting antenna tilts, azimuths, signal powers, change of frequency band and the applied bandwidth in the remaining base stations. Furthermore, remaining nodes 2A, 2B may potentially be reconfigured to apply different radio access technologies with a more suitable coverage-versus-capacity tradeoffs, e.g. applying beam forming techniques to enhance coverage. Also, neighbour cell lists and inter-/intra-network handover thresholds may be automatically updated.

It should be noted that the resources of the first wireless access network 2A may also be adjusted before handing over the first terminals 5 to the second wireless access network 2B.

It should be noted that the complementary decision algorithm may also be performed by monitoring and analyzing whether the claimed capacity by the second terminals 6 in the second network 2B is below the free capacity in the first network 2A, again possibly taking account of claimed capacity and free capacity thresholds. Operator policies can be used to determine how to proceed when both wireless access networks 2A, 2B would decide to handover the assigned terminals to each other. These policies may be based on the optimum energy consumption reduction scenarios using a coordinating entity.

The analysis module 11 may also contain or have access to a selection module 13, wherein the selection is made of the resources of the first wireless access network 2A to be adjusted in order to control the energy consumption of the first wireless access network 2A. As an example, the transmission power of system channels of the node 2A is reduced and the antenna is redirected, such that it only covers a coverage area not covered by the wireless access network 2B (see FIGS. 1A and 1B for an example, wherein some first mobile terminals 5 are not within the range of cell 3B of wireless access network 2B). Another example includes switching off the node 2A and taking over coverage of the particular first mobile terminals 5 outside the cell 3B by neighbouring cells (not shown) of the first or second wireless access networks 2A, 2B.

The claimed capacity by a first terminal 5 in the first wireless access network 2A will generally differ from the claimed capacity by this terminal in the second network 2B when handed over to the second network 2B. This may e.g. be the result of non-collocated base stations. Indeed, as can be seen in FIG. 1A, a terminal 5 is closer to the base station of network 2A than to the base station of network 2B. Consequently, if such a terminal 5 is handed over to the second network 2B, the claimed capacity from this network 2B will be higher than the capacity claimed originally from network 2A, assuming that the quality of service for this terminal 2A should remain the same before and after handover. The analysis module 11 may apply a correction factor and/or a conversion factor to take such differences into account.

Therefore, in addition to analysing the claimed capacity and free capacity in the networks 2A, 2B, the analysis module 11 may be configured to verify whether the (minimum) quality of service requirement, i.e. some service level, of first terminals 5 in network 2A can also be satisfied in network 2B. If so, the terminal 5 can be handed over safely to network 2B, provided that the performance of the second terminals 6 in the second network is not detrimentally influenced, at least is not decreased to below a minimum quality of service. If not, the terminal 5 should remain in network 2A and the adjustment of the resources of network 2A should be such that terminal 5 can still be served.

Normally, one or more of the terminals 5, 6 in the respective networks 2A, 2B will experience a quality of service above the minimum quality of service. However, by manipulating the quality of service of one or more of these terminals (i.e. reducing the quality of service) from instruction module 12, handover HO from the first network 2A to the second network 2B can be promoted. For in this case, the claimed capacity by the first terminals is reduced and the free capacity in the second network 2B is increased. Accordingly, the handover of one or more terminals 5 from the first wireless access network 2A to the second wireless access network 2B is promoted.

At some point in time, it may be required that one or more of the terminals should return to the first wireless access network 2A. This point in time may be triggered by one or more events, including, but not limited to, the claimed capacity by the terminals in the second network exceeding a claimed capacity threshold CCTh′ (see FIG. 3B) or the free capacity in the second wireless access network becoming insufficient (e.g. using a free capacity threshold FCTh′, see FIG. 3B), possibly taking account of predictions regarding the claimed capacity in the first and/or the second networks 2A, 2B and analysis of performance indicators.

However, the previous adjustment of the (resources of) the first wireless access network 2A has caused that this network is no longer able to detect any of these triggers and also is no longer able to broadcast necessary information to signal its availability and/or to connect to this network. Therefore, the second wireless access network 2B also signals the availability of the first wireless access network 2A and may possibly advertise the characteristics, e.g. the RAT, of the first wireless access network 2A. These characteristics may e.g. be obtained from the OMC 7 of the first wireless network 2A and broadcast from the second wireless access network 2B to the terminals.

As shown in FIG. 3B, the trigger for returning one or more terminals to the first wireless access network 2A is assumed to be the claimed capacity by the terminals in the second wireless access network 2B. When this claimed capacity exceeds a claimed capacity threshold CCTh′, (resources of) the first wireless access network 2A (are) is adjusted in order to be able to accommodate the one or more terminals currently served by the second wireless access network. Terminal capabilities may also be monitored and taken into account to decide which terminals should be handed over to the second wireless access network 2B.

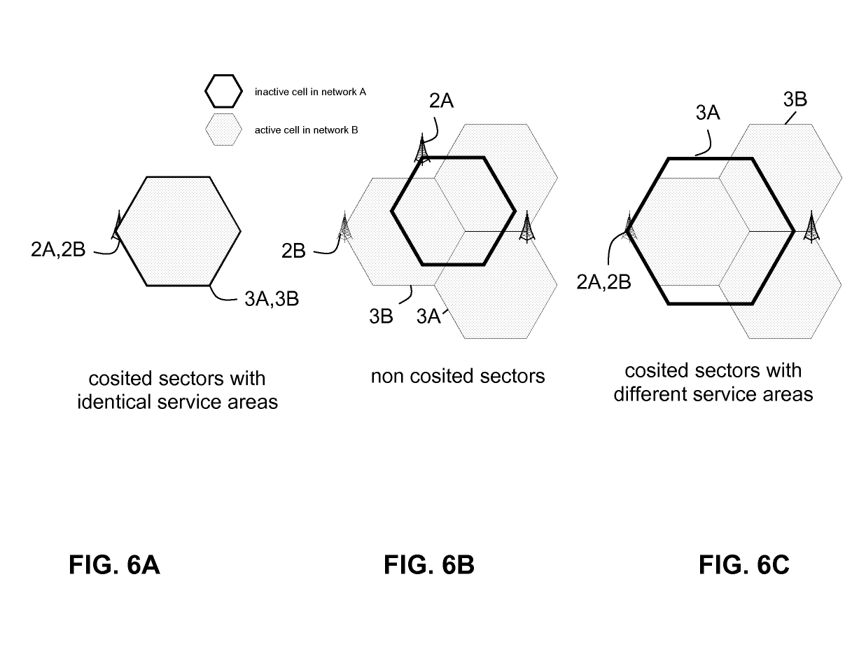

The selection of the resources to be adjusted can be performed on the basis of parameters of substantially all the terminals 5, 6 in the overlapping coverage area 4 (or the cell 3B) in the second wireless access network 2B. These parameters may include at least one of locations, capabilities and/or claimed capacities of the terminals in the second wireless access network 2B. The selection of the resources to be adjusted in the first wireless access network 2A in order to hand over some of the terminals 5, 6 from the second wireless access network 2B to the first wireless access network 2A is described in further detail with reference to FIGS. 6A-6C.

One or more of the terminals 5, 6 are then handed over to the first wireless access network 2A and the resources of the second network 2B may be adjusted again to account for the reduced number of terminals to be served.

The claimed capacity by a terminal in the second wireless access network 2B will generally differ from the claimed capacity by this terminal in the first wireless access network 2A when handed over to the first network, e.g. because of the different distances to the base station of first and second wireless access networks. The analysis module 11 may apply a correction factor and/or a conversion factor to take such differences into account.

The analysis module 11 may be used to take into account the (minimum) performance for the one or more terminals in the second wireless access network before handing over to the first wireless access network. The handover is only performed when a minimum quality of service can be expected also in the first network 2A. Examples of a quality of service parameter that may be analysed are the (minimum) throughput, affordable delay and packet loss rate for a terminal or service.

Furthermore, the claimed capacity and/or free capacity in the second wireless access network may be manipulated by instructions from the instruction module 12 by controlling the quality of service for the terminals in the second network 2B.

Lowering the quality of service for the terminals in the second network 2B may demote handover from terminals to the first wireless access network 2A as the claimed capacity of the terminals in the second wireless access network decreases. In these embodiments, the claimed capacity by the terminals may be defined as the capacity used by the terminals when the minimum quality of service target for these terminals is provided by the second wireless access network 2B, thus decreasing the originally claimed capacity in the second wireless access network. The free capacity is now defined as the unused capacity when the active terminals are served at the minimum quality of service target by the second wireless access network 2B, thus increasing the original free capacity. Accordingly, the handover of one or more terminals from the second wireless access network to the first wireless access network is demoted.

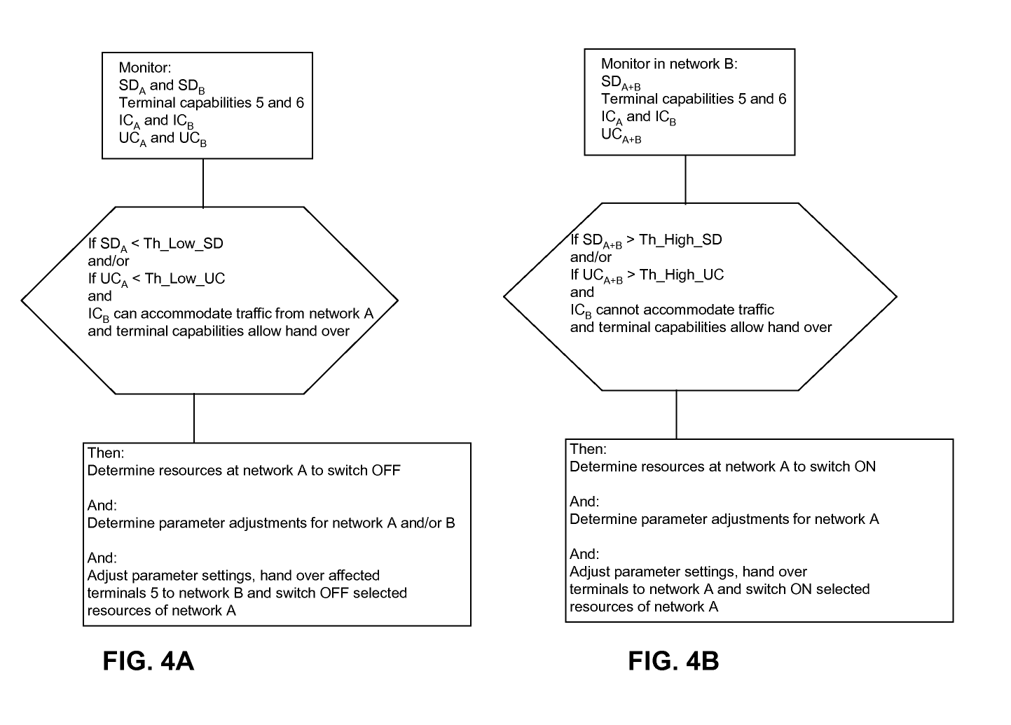

A possible realisation of the resource switch OFF and switch ON process at the base stations 2A is depicted in FIGS. 4A and 4B. The depicted processes are executed at the OMC 7 in case of centralised deployment and/or base station in case of decentralised/distributed deployment, shown in FIG. 1A. In FIGS. 4A and 4B, the claimed capacity comprises the actually used capacity UC, possibly being reduced by decreasing quality of service for some terminals as explained above.

In the monitoring step the wireless access networks 2A and 2B collect terminals' radio capabilities (supported radio access technology and frequencies), installed capacity IC_{A} and IC_{B} (e.g. number of TRXs in GSM, number of 5 MHz carriers in UMTS, bandwidth 1.4 to 20 MHz in LTE, etc) and the used capacity UC_{A} and UC_{B} in a predefined time interval (e.g. average usage of time-frequency slots per TRX in GSM, uplink noise rise and downlink average transmit power and SF code usage per 5 MHz carrier in UMTS, number of used physical resource blocks (PRBs) in uplink and downlink in LTE, etc.) for all base stations in the coverage area.

In situations when the used capacity UC_{A} is lower than a predefined utilisation threshold Th_Low_U and the installed capacity IC_{B} of the second wireless access network 2B can accommodate the traffic from network 2A, then the process is started for selecting the resources of the first wireless access network 2A to be switched off. In order to reduce the energy consumption, the selected resources may e.g. comprise an entire base station, part of a base station (sector/cell), installed spectrum (TRXs in GSM, 5 MHz carriers in UMTS, and predefined number of PRBs in LTE, etc), processing boards, transmission links, etc. After this step is performed a reconfiguration may be needed in order to keep the coverage on a satisfactory level and in order to shift the ongoing traffic towards the base stations with active resources, as illustrated in the lowest block of FIG. 4A.

In FIG. 4B, the complementary operation of switching base stations 2A back on again is illustrated. Again, in this process, quality of service effects may be analysed for verifying whether terminals can be handed over to the first wireless access network 2A or used for controlling the claimed/free capacity in the second wireless access network 2B to demote handover to network 2A. Once the utilisation of the existing capacity increases (e.g. U_{A+B} exceeds a predefined threshold Th_High_U) and/or the currently installed capacity IC_{B} cannot accommodate the traffic from terminals 5, 6 with satisfactory quality of service (QoS), then the switched-off base station(s) of the first wireless access network 2A should be all or partially switched on again to ensure that sufficient capacity remains available.

As mentioned above, it is non-trivial how claimed capacity in the area where base stations 2A are switched off is determined, simply because base stations 2A that are switched off cannot measure claimed capacity. Therefore, such estimates are made by the cooperative wireless access network 2B, which does provide coverage in that area 4. Herein, the active base stations 2B administer the calls' initially requested service level in case QoS negotiations have reduced this to a lower actual service level. Furthermore, active base stations 2B signal the availability of the first wireless access network 2A and possibly advertise the specific capabilities of the base stations that are switched off (which may very well be of a different radio access technology). Once the interest shown in those capabilities becomes significant, the base stations in question are switched back on again and parameters are adjusted, as illustrated in the lower block of FIG. 4B.

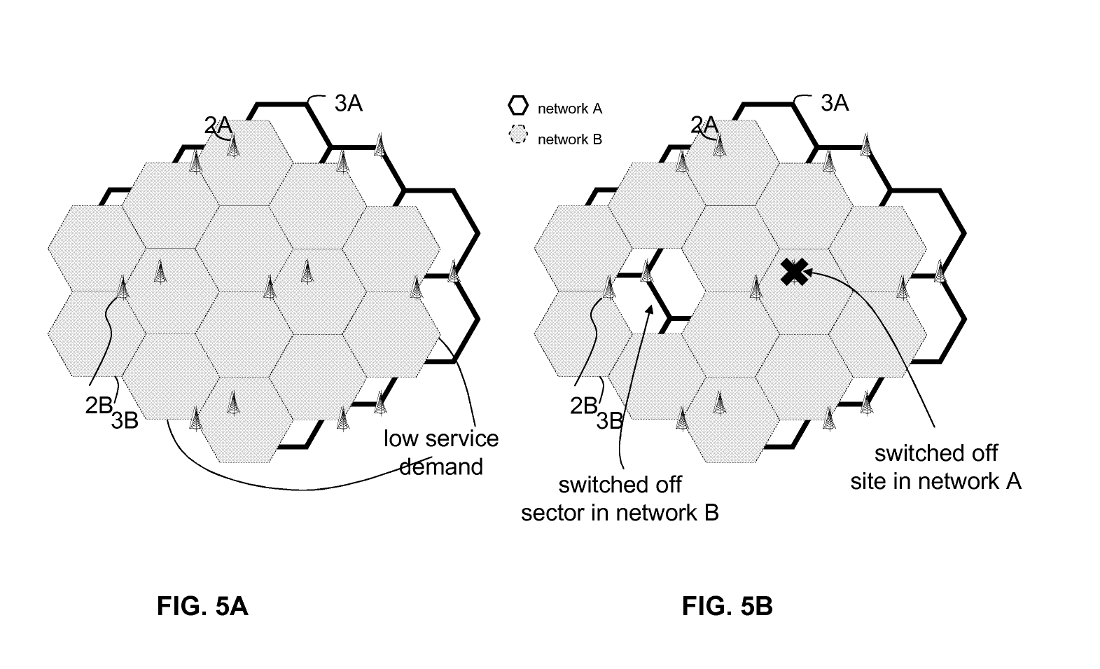

FIGS. 5A and 5B schematically depict a plurality of non-coinciding cells 3A (bold border lines), B of a wireless access networks 2A, 2B using different radio access technologies, respectively, forming a telecommunications infrastructure 1.

FIG. 5A shows the situation, wherein both networks 2A, 2B are active and a low claimed capacity is monitored in the indicated areas, as described previously with reference to FIGS. 3A and 4A. Energy consumption is then reduced in FIG. 5B by switching off a sector in network 2B and a base station in network 2A. The respective networks 2A and 2B are adjusted to maintain coverage.

As mentioned above, the second wireless access network 2B is used for monitoring claimed capacity for handover to the first wireless network 2A. FIGS. 6A-6C provide a non-exhaustive set of illustrations of possible scenarios with different degrees of complexity in terms of determining which resources of the first wireless network 2A to switch on again.

For instance, FIG. 6A indicates two co-sited cells of network 2A and 2B, respectively, with fully overlapping coverage areas 3A, 3B. In such a scenario it is relatively straightforward for the active cell of network 2B to estimate the total claimed capacity in the common coverage area, as an input for the algorithm to select inactive cells of network 2A to switch on again.

In the cases illustrated in FIGS. 6B and 6C, the coverage area of the inactive cell in network 2A only partially overlaps with those of multiple active cells in network 2B. In such scenarios each active cell of network 2B may estimate which fraction of its observed claimed capacity falls within the coverage area of the inactive cell of network 2A. This can be done with an application of localisation techniques, involving e.g. GPS, triangulation, timing advance values, angle of arrival, etc. The coordinating entity, e.g. a node 2B or the OMC 7, may then aggregate these fractional estimates to derive an estimate for the overall service demand in the inactive cell and to seect which resources of the first wireless access network 2A should be adjusted. Of course, other possibilities exist, such as estimates from planning programs or estimates based on historical data.

1. A network control system configured for use in a telecommunications infrastructure comprising a first wireless access network and a second wireless access network, the first and second wireless access network being capable of providing services in an overlapping coverage area to a plurality of first terminals and a plurality of second terminals respectively, wherein the network control system comprises a monitoring system configured for monitoring at least:
claimed capacity in at least the overlapping coverage area by the first terminals in the first wireless access network; and
free capacity in the second wireless access network for providing the services in the overlapping coverage area;
wherein the network control system is configured for:
handing over one or more of the first terminals in the overlapping coverage area from the first wireless access network to the second wireless access network after the free capacity in the second wireless access network exceeding the claimed capacity in the first wireless access network for providing services to the first terminals from the second wireless access network; and
adjusting one or more resources of the first wireless access network.

2. The network control system according to claim 1, wherein the network control system comprises an analysis module configured for analysing at least one quality of service effect for at least one of the first terminals before handing over to the second network and determining whether the quality of service effect meets a quality of service target.

3. The network control system according to claim 1, wherein the network control system is configured for controlling at least one of the claimed capacity and the free capacity by controlling at least one quality of service parameter for at least one of the first and second terminals, respectively.

4. A network control system configured for use in a telecommunications infrastructure comprising a first wireless access network and a second wireless access network, the first and second wireless access network each being capable of providing services in an overlapping coverage area to a plurality of terminals, wherein the system comprises a monitoring system configured for monitoring in the second wireless access network claimed capacity by the terminals and/or a free capacity in the second wireless access network when the first wireless access network does not serve terminals in the overlapping coverage area, and wherein the network control system is configured for:
adjusting one or more resources of the first wireless access network after the claimed capacity by the terminals exceeding a claimed capacity threshold for the second wireless access network and/or the free capacity in the second wireless excess network decreases below a free capacity threshold;
handing over one or more of the terminals in the overlapping coverage area from the second wireless access network to the first wireless access network using the adjusted resources of the first wireless access network such that the claimed capacity by the terminals remaining in the second wireless access network is lowered to at least the claimed capacity threshold and/or the free capacity in the second network is increased to at least the free capacity threshold.

5. The network control system according to claim 4, wherein the second wireless access network is configured for informing the terminals of the availability of the first wireless access network and, optionally, one or more characteristics of the first wireless access network.

6. The network control system according to claim 4, wherein the network control system is configured for:
determining one or more parameters, wherein the parameters comprise at least one of locations, capabilities, and claimed capacities in at least one of the first wireless access network and the second wireless access network;
determining the one or more resources to be adjusted in dependence on the determined parameters of the one or more terminals.

7. The network control system according to claim 4, wherein the network control system comprises an analysis module configured for analysing at least one quality of service effect for at least one of the terminals before handing over to the first network and determining whether the quality of service effect meets a quality of service target.

8. The network control system according to claim 4, wherein the network control system is configured for controlling the claimed capacity and the free capacity by controlling at least one quality of service parameter for the terminals.

9. A method for controlling a telecommunications infrastructure comprising a first wireless access network and a second wireless access network, the first and second wireless access network being capable of providing services in an overlapping coverage area to a plurality of first terminals and a plurality of second terminals respectively, the method comprising the steps of:
monitoring claimed capacity in at least the overlapping coverage area by the first terminals in the first wireless access network;
monitoring free capacity of the second wireless access network for providing services in the overlapping coverage area;
providing a handover indication when the free capacity in the overlapping coverage area of the second wireless access network exceeds the claimed capacity in the overlapping coverage area of the first wireless access network;
after obtaining the handover indication, handing over one or more of the first terminals in the overlapping coverage area from the first wireless access network to the second wireless access network for providing services to the first terminals from the second wireless access network; and
controlling the telecommunications infrastructure by adjusting one or more resources of the first wireless access network.

10. The method according to claim 9, further comprising the step of analysing at least one quality of service effect for at least one of the terminals before handing over to the first network and determining whether the quality of service effect meets a quality of service target.

11. The method according to claim 9, further comprising the step of controlling at least one of the claimed capacity and the free capacity by controlling at least one quality of service parameter for at least one of the first and second terminals, respectively.

12. A method for controlling a telecommunications infrastructure comprising a first wireless access network and a second wireless access network, the first and second wireless access network each being capable of providing services in an overlapping coverage area to a plurality of terminals, the method comprising the steps of:
monitoring in the second wireless access network claimed capacity by the terminals and/or the free capacity in the second wireless access network when the first wireless access network does not serve terminals in the overlapping coverage area;
controlling the telecommunications infrastructure by adjusting one or more resources of the first wireless access network after the claimed capacity by the terminals exceeding a claimed capacity threshold for the second wireless access network and/or a free capacity in the second wireless access network decreases below a free capacity threshold;
handing over one or more of the terminals in the overlapping coverage area from the second wireless access network to the first wireless access network using the adjusted resources of the first wireless access network such that the claimed capacity by the terminals remaining in the second wireless access network is lowered to at least the claimed capacity threshold and/or the free capacity in the second wireless access network is increased to at least the free capacity threshold.

13. The method according to claim 12, further comprising the step of informing the terminals in the second wireless access network of the availability of the first wireless access network and, optionally, of one or more characteristics of the first wireless access network.

14. The method according to claim 12, further comprising the steps of:
determining one or more parameters, wherein the parameters comprise at least one of locations, capabilities, and claimed capacities in at least one of the first wireless access network and the second wireless access network;
determining the one or more resources to be adjusted in dependence on the determined parameters of the one or more terminals.

15. The method according to claim 12, further comprising the step of analysing at least one quality of service effect for at least one of the terminals before handing over to the first network and determining whether the quality of service effect meets a quality of service target.

16. The method according to claim 12, further comprising the step of controlling the claimed capacity and the free capacity by controlling at least one quality of service parameter for the terminals.

17. A computer program comprising software code portions configured for, when executed by a processor, performing one or more steps of the method according claim 9.

18. A computer program comprising software code portions configured for, when executed by a processor, performing one or more steps of the method according claim 12.
